(19) United States
(12) Patent Application Publication
(10) Pub. No.: US 2013/0290156 A1
(43) Pub. Date: Oct. 31, 2013

(54) Bit Selection Using Bit Fleet Management

(71) Applicant: Stuart Norris, Houston, TX (US)

(72) Inventor: Stuart Norris, Houston, TX (US)

(73) Assignee: Varel International Ind., L.P., Carrollton, TX (US)

(21) Appl. No.: 13/458,480

(22) Filed: Apr. 27, 2012

(51) Int. Cl. G06Q 40/00

(52) U.S. Cl. 705/35

(57) ABSTRACT

A system is described herein for selecting a bit from a bit fleet for use in a field operation. The system includes a subjective module, an objective module, a financial module, and a management engine, each of which executes on a hardware processor. The subjective module determines whether subjective bit performance data points exceed a subjective threshold. The objective module determines whether objective bit performance data points exceed an objective threshold. The financial module determines whether financial bit performance data points exceed a financial threshold. The management engine receives bit data, evaluates bit performance parameters, categorizes the bit performance parameters to generate one or more categorized bit performance parameters, and determines whether the bit is usable in the field operation.

### TECHNICAL FIELD

The present disclosure relates generally to bit fleet management, and more particularly to systems, methods, and devices for selecting a bit for a field operation using bit fleet management.

### BACKGROUND

Optimization of drill bit designs, drill bit operating parameters, and drill bit selection and well programming techniques using certain platforms are known in the art. Examples of these platforms include the Schlumberger “Ideas” platform, the Varel “GeoSciences” and “SPOT” platforms, and the Halliburton “SPARTA” and “iBitS” platforms. All of these technologies assist operators in choosing a specific bit for a specific application and aid in planning the proper operating parameters to be used with the specific bit in the specific application. Even with these tools, however, optimum drill bit economic value to the operator is underachieved. The shortfall of the existing tools is that they fail to take into account the field reality of the extensive use of repair, rerun, and rental bits in the marketplace. The prior art solutions are typically based on new bits, and in some instances, new bits going through a wear curve while drilling a specific well section. These prior art solutions do not take into account the use of semi-worn or repaired bits to drill an entire section or sections. In addition, the prior art methods and software tools fail to include drill bit economics from a fleet management, fleet life cycle, and fleet economics viewpoint. This oversight may represent millions of dollars of lost efficiency and value for the oil well operators, the rig contractors, and the drill bit providers.

### BRIEF DESCRIPTION OF THE DRAWINGS

The drawings illustrate only exemplary embodiments of bit selection using bit fleet management and are therefore not to be considered limiting of its scope, as the disclosure may admit to other equally effective embodiments. The elements and features shown in the drawings are not necessarily to scale, emphasis instead being placed upon clearly illustrating the principles of the exemplary embodiments. Additionally, certain dimensions or positionings may be exaggerated to help visually convey such principles. In the drawings, reference numerals designate like or corresponding, but not necessarily identical, elements.

FIG. 1 shows a diagram of a system in accordance with one or more exemplary embodiments;

FIG. 2 shows a flowchart of a method in accordance with one or more exemplary embodiments;

FIG. 3 shows a computing device in accordance with one or more exemplary embodiments; and

FIGS. 4A through 4H show an example in accordance with one or more exemplary embodiments.

### DETAILED DESCRIPTION

Exemplary embodiments of bit selection using bit fleet management will now be described in detail with reference to the accompanying figures. Like elements in the various figures are denoted by like reference numerals for consistency.

In the following detailed description of exemplary embodiments of bit selection using bit fleet management, numerous specific details are set forth in order to provide a more thorough understanding of bit selection using bit fleet management. However, it will be apparent to one of ordinary skill in the art that bit selection using bit fleet management may be practiced without these specific details. In other instances, well-known features have not been described in detail to avoid unnecessarily complicating the description. Further, certain descriptions (e.g., top, bottom, side, end, interior, inside) are merely intended to help clarify aspects of bit selection using bit fleet management and are not meant to limit embodiments of bit selection using bit fleet management.

In general, exemplary embodiments of bit selection using bit fleet management provide systems, methods, and devices for creating a bit management system and using such system to assess whether a particular bit, whether new or used, within a bit fleet is well suited for a particular field operation. Specifically, exemplary embodiments of bit selection using bit fleet management provide for using a number of different data sources to collect various information with regard to a number of bits in the bit fleet, integrating data from the different data sources, and using the data, in conjunction with subjective, objective, and financial models, to determine whether a particular bit exceeds certain criteria with regard to a particular field operation. In such a case, the bit is selected to perform the field operation.

A bit fleet is a grouping of one or more bits, whether new, previously used, or previously used and repaired, that are available to be used in drilling applications. The bits are further grouped based on one or more of a number of factors, including but not limited to bit type (e.g., polycrystalline diamond compact (PDC) bits), number of cutters, size of bit, location of the field operation, types of formation drilled through during a field operation, operator of the bit, and age of the bit, in certain exemplary embodiments.

Exemplary embodiments discussed herein are with reference to performing a field operation. A field may be any formation (e.g., rock, sand, ice). The field operation is performed to reach and/or extract a subterranean material and/or formation in certain exemplary embodiments. Such a material includes, but is not limited to, a hydrocarbon (e.g., oil, natural gas), coal, a metal, hydrogen, and water. A field operation is also related to finding a subterranean formation that is used for storage, as for natural gas or carbon dioxide, according to certain exemplary embodiments.

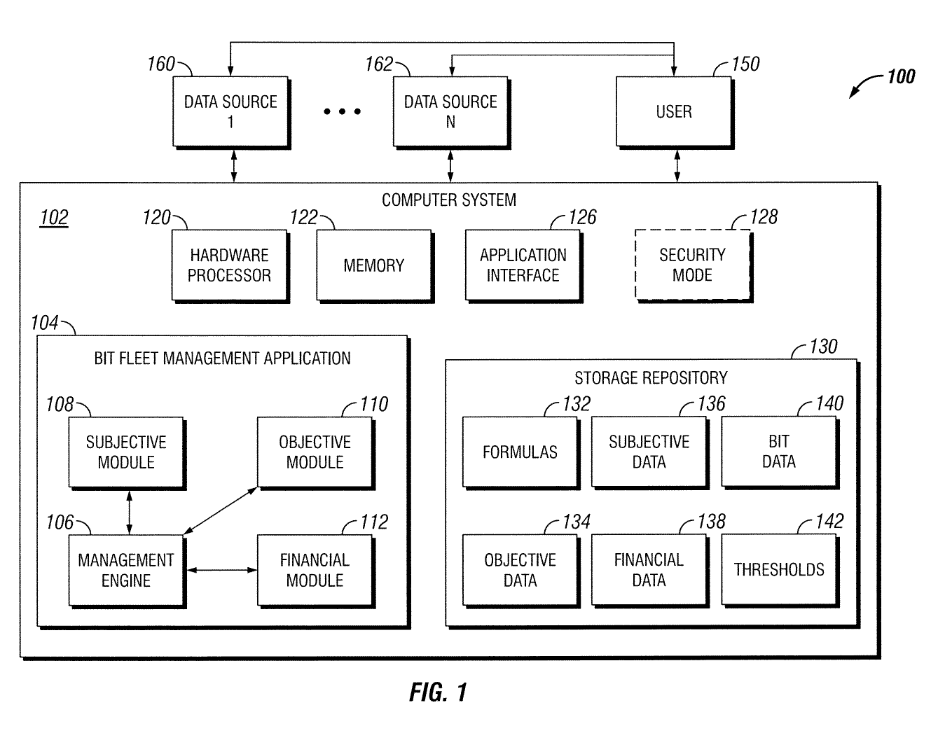

FIG. 1 shows a diagram of a system 100 in accordance with one or more exemplary embodiments. The system 100 includes a computer system 102, a number of data sources (e.g., data source 1 160, data source N 162), and a user 150. The computer system 102 includes a bit fleet management application 104, a storage repository 130, a hardware processor 120, a memory 122, an application interface 126, and, optionally, a security module 128. The bit fleet management application 104 includes a management engine 106, a subjective module 108, an objective module 110, and a financial module 112. The storage repository 130 includes formulas 132, objective data 134, subjective data 136, financial data 138, bit data 140, and thresholds 142. Each of these components is described in further detail below. Exemplary embodiments are not limited to the configuration shown in FIG. 1 and discussed herein. Additionally, although certain components have been enumerated as being part of the system 100, it is understood that some components are combined with other components and/or some components are further divided into additional components in other alternative exemplary embodiments.

In one or more exemplary embodiments, the computer system 102 is implemented according to a client-server topology. The computer system 102 may correspond to enterprise software running on one or more servers, and in some embodiments may be implemented as a peer-to-peer system, or resident upon a single computing system. In addition, the computer system 102 may be accessible from other machines using one or more application programming interfaces and/or user interfaces (not shown). In one or more exemplary embodiments, the computer system 102 may be accessible over a network connection (not shown), such as the Internet, by one or more users (e.g., advertiser, user, financial transaction source, etc.). Further, information and/or services provided by the computer system 102 may also be stored and accessed over the network connection.

Alternatively or additionally, in one or more exemplary embodiments, the computer system 102 is a local computer system of the user 150 and/or of one or more data sources (e.g., data source 1 160, data source N 162). In such embodiments, the computer system 102 is, optionally, not implemented using a client-server topology. For example, the computer system 102 corresponds to a laptop computer, desktop computer, mobile device, another type of computing device, or a combination of multiple computing devices. Additionally or alternatively, the computer system 102 is a distributed computer system and/or a multi-processor computer system in which the computer system includes multiple distinct computing devices.

Continuing with FIG. 1, the user 150 uses one or more bit selection applications (not shown) to communicate with the computer system 102 in accordance with one or more exemplary embodiments. For example, the user 150 receives a notification from the computer system 102 as to the bit selected for a particular field operation. According to some exemplary embodiments, the user 150 is an engineer, a company representative, a driller, a salesman, an agent, a broker, a consultant, a representative of a seller, an accountant, or some other entity with an interest in selecting a bit for a field operation.

According to some exemplary embodiments, the user 150 sends information (e.g., user preferences, settings, data) to the computer system 102 in a number of manners (e.g., modes of communication), including but not limited to the mail, a telephone, an email, a fax, a short message service, over the Internet, some other suitable mode for sending information, or any combination thereof In certain exemplary embodiments, the information sent by the user 150 to the computer system 102 is delivered automatically (e.g., according to a default setting, a consumer preference, an occurrence of an event) or on demand, for example, in response to a request from the computer system 102. The computer system 102 interacts with the user 150 in the same manner that the user 150 interacts with the computer system 102, or in a different manner using different modes of communication. The user 150 uses a user system (not shown), which is discussed below in further detail, to interact with the computer system 102 using software (not shown) in accordance with one or more exemplary embodiments.

In one or more exemplary embodiments, the user 150 interacts with one or more data sources (e.g., data source 1 160, data source N 162). Specifically and according to some exemplary embodiments, the user 150 sends information (e.g., geological data, data regarding a bit, operational data from a field operation) to and receives information from one or more data sources (e.g., data source 1 160, data source N 162).

In one or more exemplary embodiments, the user 150 sends information to the data source 160, 162 in a number of manners (e.g., modes of communication), including but not limited to the mail, the telephone, the email, the fax, the short message service, over the Internet, some other suitable mode for sending information, or any combination thereof Further, the user 150 receives information from the data source 160, 162 in some exemplary embodiments. The information is delivered automatically (e.g., according to a default setting, a consumer preference, an occurrence of an event) or on demand, for example, in response to a request from the data source 160, 162. In certain exemplary embodiments, the data source interacts with the user 150 in the same manner that the user 150 interacts with the data source 160, 162, or in a different manner using different modes of communication. The user 150 uses the user system (not shown), which is described below in further detail, to interact with the data source 160, 162 using software (not shown) in accordance with one or more exemplary embodiments.

In one or more exemplary embodiments, the data source (e.g., data source 1 160, data source N 162) is an entity and/or system capable of receiving, sending, manipulating, and/or storing information associated with a bit and/or a field operation. Examples of the data source 160, 162 include, but are not limited to, a model, a database, a spreadsheet, a vendor list, a list of specifications, an accounting ledger, a financial table, and the user 150. A number of data sources 160, 162 is used to receive, send, manipulate, and/or store information associated with the bit and/or the field operation according to some exemplary embodiments.

In one or more exemplary embodiments, each data source (e.g., data source 1 160, data source N 162) sends information (e.g., bit data, field data, financial data, operational data) to, and receives information (e.g., a request for bit data for a particular bit) from, the computer system 102. The information is delivered automatically (e.g., according to a default setting, a marketing entity preference, an occurrence of an event) or on demand, as from a request made by the computer system 102. The data provided by the data sources 160, 162 includes, but is not limited to, one or more of a serial number of a bit, an assembly of a bit, a leach type of a bit, a size of a bit, a type of bit, a tool head number for a bit, a number of runs for a bit, a primary owner of a bit, a plant to which a bit is assigned, a profit center that owns a bit, a standard primary cutter of a bit, a standard cutter of a bit, an original manufacturing date of a bit, an age of a bit, a date of the LGM (last goods movement) for a bit, a number of days since LGM for a bit, an original cost of a bit, an accumulated depreciation of a bit, a revised value of a bit, a total revenue generated using a bit, a total repair cost of a bit, a total royalty of a bit, a margin of a bit, a total runs of a bit, a total partial lost cutters of a bit, a total lost cutters of a bit, a total rotations of cutters for a bit, a total pocket repairs for a bit, a total cutters replaced for a bit, a total feet drilled with a bit, an operator, a longitude of a field, a latitude of a field, a lease name of a field, a lease number of a field, a section of a field, a township of a field, a range of a field, a field name, a country of a field, a state of a field, a county of a field, a target depth for a run, a footage drilled for a run, a start depth of a run, an end depth of a run, a rate of penetration for a run, a dull grade of a bit, a billing date for use of a bit, a repair date of a bit, a repair facility, a ratings of a bit, and an overall ratings of a bit.

Each data source 160, 162 interacts with the computer system 102 in the same mode of communication that the computer system 102 interacts with the data source 160, 162 or using different modes of communication in alternative exemplary embodiments. In one or more exemplary embodiments, each data source 160, 162 uses a data source system (not shown) to interact with the computer system 102 using data source software (not shown), which is discussed in further detail below.

The computer system 102 also is implemented as a browser extension according to some exemplary embodiments. In such a scenario, user software and/or data source software interacts directly with the computer system 102 as a browser extension.

Continuing with FIG. 1, the computer system 102 interacts with the user 150 and/or each data source (e.g., data source 1 160, data source N 162) using an application interface 126 in accordance with one or more exemplary embodiments. Specifically, the application interface 126 of the computer system 102 receives input from and sends output to the user 150 and/or each data source 160, 162. The user 150 and/or each data source 160, 162 includes an interface to receive data from and send data to the computer system 102 in certain exemplary embodiments. Examples of this interface include, but are not limited to, a graphical user interface, an application programming interface, a keyboard, a monitor, a mouse, a web service, a data protocol adapter, some other hardware and/or software, or any suitable combination thereof.

In one or more embodiments of the invention, the information received by the application interface 126 includes, but is not limited to, bit data, field data, financial data, operational data, user preferences, settings, and feedback. The information sent by the application interface 126 includes, but is not limited to, a request for field data, a notification that a particular bit should be used for a field operation, and a request for additional information. The information sent by the application interface 126 specifies, but is not limited to, a user, a field location, a data source, a Uniform Resource Identifier (URI) (e.g., a Uniform Resource Locator (URL), a web address, etc.), data identified by and/or requested by the management engine 106, some other software or source of information, or any suitable combination thereof.

In one or more embodiments of the invention, the information (i.e., data) transferred among the application interface 126, the user 150, and/or each data source (e.g., data source 1 160, data source N 162) corresponds to metadata associated with such information. In this case, the metadata describes the data specified (i.e., the metadata provides context for the specified data). In one or more embodiments of the invention, the computer system 102 supports various data formats provided by the user 150 and/or each data source 160, 162.

Continuing with FIG. 1, the computer system 102 retrieves and stores formulas 132, objective data 134, subjective data 136, financial data 138, bit data 140, and thresholds 142. More specifically, the computer system 102 uses the management engine 106 to retrieve and store formulas 132, objective data 134, subjective data 136, financial data 138, bit data 140, and thresholds 142 in the storage repository 130 in accordance with one or more exemplary embodiments.

In one or more exemplary embodiments, a formula includes an equation, set of parameters, or other means of using quantitative data to reach a numerical result. The formulas 132 of the storage repository 130 includes one or more formulas. Each formula is fixed in certain exemplary embodiments, or is adjusted based on recent trends, user input, and/or any other information that affects the result produced by the formula in other exemplary embodiments. A formula is directly or indirectly associated with one or more bits. A formula is financial-based, performance-based, and/or operationally-based according to certain exemplary embodiments. As an example, a formula 132 for wellbore quality (a bit performance parameter, which is described in further detail below) is caliper diameter/nominal diameter. As another example, a formula 132 for directional response (another bit performance parameter) for a rotary bit is sliding time/drilling time. As yet another example, a formula 132 for vibration index (yet another bit performance parameter) is (magnitude−average)/average.

In one or more exemplary embodiments, the objective data 134 of the storage repository 130 includes any objective data that is directly or indirectly associated with a bit. Objective data 134 is based on actual and/or measured data. Examples of objective data 134 include, but are not limited to, footage drilled, number of runs, rate of penetration per run, bit rental cost, bit repair cost, bit cost, total bit life (e.g., runs, feet, meters), cutter class (e.g., generic, enhanced, premium, super premium), and cutter cost (e.g., per cutter, over life of bit).

In one or more exemplary embodiments, the subjective data 136 of the storage repository 130 includes any subjective data that is directly or indirectly associated with a bit. Subjective data 136 is based on data that cannot be (or is difficult to be) independently evaluated. Examples of subjective data 136 include, but are not limited to, wellbore quality, directional response/drilling target acquisition, total vibration, and peak vibration.

In one or more exemplary embodiments, the financial data 138 of the storage repository 130 includes any financial data that is directly or indirectly associated with a bit. Financial data 138 is economic in nature and is either subjective and/or objective data. Financial data 138 is specific to a bit (e.g., purchase cost of the bit, repair cost of the bit), specific to a field operation, or general (e.g., rate of interest) according to various exemplary embodiments. Examples of financial data 138 include, but is not limited to, total cash payment and total bit provider invested cost.

In one or more exemplary embodiments, the bit data 140 of the storage repository 130 includes any bit data that is associated with a bit. Bit data 140 is, for example, geographic, operational, and/or time-based. Bit data 140 is associated with an entire bit or portions (e.g., cutters) of a bit. Examples of bit data 140 include, but is not limited to, total bit life, bit serial number, bit assembly number, bit type, bit usage region, run start depth, run end depth, and usage zone longitude and latitude. In certain exemplary embodiments, the bit data 140 for the bit and/or the bit fleet is associated with PDC bits.

In one or more exemplary embodiments, the thresholds 142 of the storage repository 130 are a measure of one or more of a number of data points and/or parameters. Specifically, the thresholds 142 represent values or ranges of values that measure the strength of a data point. A number of different thresholds 142 is stored in the storage repository 130. Examples of different thresholds 142 include, but are not limited to, subjective thresholds (used to evaluate one or more subjective bit performance data points), objective thresholds (used to evaluate one or more objective bit performance data points), financial thresholds (used to evaluate one or more financial bit performance data points), and rating categories (used to categorize one or more bit performance parameters). Each threshold 142 is a single number, a range of numbers, a word, and/or some other suitable measure depending upon the exemplary embodiment. Each threshold 142 is fixed according to some exemplary embodiments, while in other exemplary embodiments, each threshold 142 varies based on one or more of a number of factors, including but not limited to one or more items of bit data, geographic data, operational data, financial data, objective data, and/or subjective data.

Continuing with FIG. 1, the storage repository 130 is a persistent storage device (or set of devices) that stores software and data used to assist the management engine 106 in selecting a bit for a field operation. In one or more exemplary embodiments, the storage repository 130 stores the formulas 132, objective data 134, subjective data 136, financial data 138, bit data 140, and thresholds 142. Examples of a storage repository 130 include, but are not limited to, a database (or a number of databases), a file system, a hard drive, some other form of data storage, or any suitable combination thereof. The storage repository 130 is located on multiple physical machines, each storing all or a portion of the formulas 132, objective data 134, subjective data 136, financial data 138, bit data 140, and thresholds 142 according to some exemplary embodiments. Each storage unit or device is physically located in the same or different geographic location.

The storage repository 130 is operatively connected to the bit fleet management application 104. In one or more exemplary embodiments, the bit fleet management application 104 includes functionality to select a bit within the bit fleet for a field application. More specifically, the bit fleet management application 104 sends information to and/or receives information from the storage repository 130 in order to select a bit from the bit fleet for a field operation. The functions of the bit fleet management application 104 is performed on a single computing device or on multiple computing devices. When the functions of the bit fleet management application 104 are performed on multiple computing devices, a number of configurations and/or frameworks are used in certain exemplary embodiments. The configurations and/or software frameworks are designed to work with multiple data nodes and large quantities of data. One or more calculations performed by one or more components of the bit fleet management application 104 are performed on multiple machines operating in parallel, where the results from each machine is combined to generate a result to the one or more calculations.

Each component of the bit fleet management application 104 described herein (specifically, the management engine 106, the subjective module 108, the objective module 110, and the financial module 112) uses one or more algorithms to perform one or more calculations. Each algorithm is designed to receive specific types of data and generate one or more specific results using such data. A specific result is a number, a range of numbers, a rating, and/or some other suitable output according to some exemplary embodiments. Each algorithm is fixed, variable, self-adjusting, or otherwise changed. Each algorithm uses one or more pieces of data from one or more areas of data (e.g., bit data, field data, financial data, geological data, operational data).

In one or more embodiments of the invention, the management engine 106 of the bit fleet management application 104 coordinates the objective module 110, the subjective module 108, the financial module 112, the storage repository 130, and, optionally, the security module 128. Specifically, the management engine 106 coordinates the transfer of information between the application interface 126, the storage repository 130, and the other components of the bit fleet management application 104 according to certain exemplary embodiments.

Further, the management engine 106 also retrieves the formulas 132, the objective data 134, the subjective data 136, the financial data 138, the bit data 140, and the thresholds 142 from, and sends the formulas 132, the objective data 134, the subjective data 136, the financial data 138, the bit data 140, and the thresholds 142 to the storage repository 130 for use by the management engine 106 or by other components of the bit fleet management application 104. The management engine 106 also retrieves the formulas 132, the objective data 134, the subjective data 136, the financial data 138, the bit data 140, and the thresholds 142 from the storage repository 130 to be sent to the user 150 and/or one or more data sources 160, 162.

Continuing with FIG. 1, the management engine 106 retrieves, in exemplary embodiments, information needed and/or requested by the objective module 110, the subjective module 108, and/or the financial module 112. The management engine 106 retrieves specific types of information (e.g., geological data) from the data repository 130 and/or one or more specific data sources 160, 162. Alternatively, the management engine 106 queries all data sources 160, 162 and the storage repository 130 for any information needed and/or requested by the objective module 110, the subjective module 108, and/or the financial module 112.

In certain exemplary embodiments, the management engine 106 receives data (e.g., bit data, financial data, geographic data, operational data, any other suitable type of data) from the one or more data sources (e.g., data source 1 160, data source N 162). The management engine 106 also sends a request for data to the one or more data sources 160, 162 in certain exemplary embodiments. A request is for a specific type of data in some exemplary embodiments. A request also is sent to a specific data source 160, 162 according to some exemplary embodiments. A request is sent based on one or more of a number of events, including but not limited to passage of time and a need identified by a module (e.g., the subjective module 108, the objective module 110, the financial module 112). Any request sent and/or data received by the management engine 106 is executed using the application interface 126.

The management engine 106 also sends data to, and receives data from, each of the modules (the subjective module 108, the objective module 110, the financial module 112) of the bit fleet management application 104. The data received from a module includes results after executing a model of the respective module according to some exemplary embodiments. The management engine 106 further compares the results received from one or more modules with one or more criteria. Alternatively, or in addition, as discussed below, one or more modules compares the results generated by one or more modules with one or more criteria.

In one or more exemplary embodiments, the management engine 106 also evaluates a number of bit performance parameters for the bit. The evaluation performed by the management engine 106 is based on one or more financial bit performance data points exceeding a financial threshold (described below). The management engine 106 uses bit data to perform the evaluation. Examples of the bit performance parameters includes, but are not limited to, target depth versus actual footage drilled, repair cost as a percentage of revenue, margin per run, wellbore quality, directional response, and vibration index.

The management engine 106 also categorizes one or more of the bit performance parameters. In such a case, categorized bit performance parameters result. In certain exemplary embodiments, there are two or more rating categories for each of the bit performance parameters. Each category includes a nomination (e.g., number, percentage) or range of nominations. For example, when the bit performance parameter is margin per run, the rating category of “Good” ranges from 75% to 100%, the rating category of “Fair” ranges from 26% to 74%, and the rating category of “Bad” ranges from 0% to 25%. However, these ranges for each category are different in other exemplary embodiments based upon user preferences.

The management engine 106 further determines whether the bit should be used in the field operation based on the categorized bit performance parameters. For example, if the bit is categorized as “excellent” for each of the bit performance parameters, then the management engine 106 determines that the bit should be used in the field operation.

In certain embodiments, the management engine 106 also sends a notification. Specifically, the management engine 106 sends a notification to the user 150 to show the user the categorization for one or more of the bit performance parameters. The management engine 106 also sends one or more other types of notifications, including but not limited to a recommendation not to use a particular bit for a particular field operation. Any notification sent by the management engine 106 includes other supporting data, including but not limited to a summary of the evaluation for one or more bit performance parameters, a legend of categories and corresponding ranges of nominations each category, and a summary of information provided with regard to the field and/or the corresponding field operation.

In one or more exemplary embodiments, the subjective module 108 runs one or more subjective models using data (e.g., bit data, field data, financial data, geological data, operational data). Each subjective model is used to evaluate one or more subjective bit performance data points using the data. Examples of such subjective bit performance data points include, but are not limited to, wellbore quality, directional response/drilling target acquisition, total vibration, and peak vibration.

The subjective module 108 determines whether a bit exceeds one or more subjective thresholds for the field operation. The subjective module 108 determines whether the bit exceeds one or more subjective thresholds using data (e.g., bit data) received from one or more data sources 160, 162. The bit is a particular bit, whether new or previously used, a family of bits, or some other categorization of multiple bits according to certain exemplary embodiments. The one or more subjective thresholds is among the thresholds 142 in certain exemplary embodiments.

In one or more exemplary embodiments, the objective module 110 runs one or more objective models using data. The data used by the objective module 110 is the same and/or different data than the data used by the subjective module 108. Each objective model is used to evaluate one or more objective bit performance data points using the data. Examples of such objective bit performance data points include, but are not limited to, footage drilled per run, rate of penetration per run, bit rental per run, bit repair cost per run, bit cost, total bit life, cutter class, and cutter cost.

The objective module 110 determines whether the bit exceeds one or more objective thresholds for the field operation. The objective module 110 determines whether the bit exceeds one or more objective thresholds based on the bit exceeding the subjective thresholds (as determined by the subjective module 108) for the field operation and using data, including but not limited to the bit data. The one or more objective thresholds is among the thresholds 142 in certain exemplary embodiments.

In one or more exemplary embodiments, the financial module 112 runs one or more financial models using data. The data used by the financial module 112 is the same and/or different data than the data used by the subjective module 108 and/or the objective module 110. Each financial model is used to evaluate one or more financial bit performance data points using the data according to certain exemplary embodiments. Examples of such financial bit performance data points include, but are not limited to, total cash payment divided by total bit life, total cash payment divided by total bit provider invested cost, and total bit provider invested cost divided by total bit life.

In certain exemplary embodiments, the financial module 112 determines that the bit exceeds one or more financial thresholds for the field operation. The financial module 112 determines whether the bit exceeds the financial thresholds based on the bit exceeding the objective thresholds (as determined by the objective module 110) for the field operation and using data, including but not limited to the bit data. The one or more financial thresholds is among the thresholds 142.

Continuing with FIG. 1, the hardware processor 120 within the computer system 102 executes software in accordance with one or more embodiments of the invention. Specifically, the hardware processor 120 executes the computer system 102 or any of the engines, modules, and repositories described above and shown in FIG. 1, as well as software used by the user 150 and/or one or more data sources 160, 162. The hardware processor 120 is an integrated circuit, a central processing unit, a multi-core processing chip, a multi-chip module including multiple multi-core processing chips, or other hardware processor in one or more exemplary embodiments. The hardware processor 120 is known by other names, including but not limited to a computer processor, a microprocessor, and a multi-core processor. In one or more embodiments of the invention, the hardware processor 120 executes software instructions stored in memory 122. The memory 122 includes one or more cache memories, main memory, and/or any other suitable type of memory. The memory 122 is discretely located on the computer system 102 relative to the hardware processor 120 according to some exemplary embodiments. In certain configurations, the memory 122 also is integrated with the hardware processor 120.

Optionally, in one or more exemplary embodiments, the security module 128 secures interactions between the computer system 102 and the user 150 and/or the data source 160, 162. More specifically, the security module 128 authenticates communication from software based on security keys verifying the identity of the source of the communication. For example, user software may be associated with a security key enabling the user software to interact with the computer system 102. Further, the security module 128 restricts receipt of information, requests for information, and/or access to information in some exemplary embodiments.

The user software and/or data source software interacts with the computer system 102 using a browser extension. In this case, the browser extension maintains an active session with the computer system 102 after the security module 128 has authenticated the user software and/or data source software. For example, the browser extension continues to interact with the computer system 102 as the user 150 views various web content in the user software. In this example, the browser extension receives notifications from the computer system 102 for presenting to the user 150.

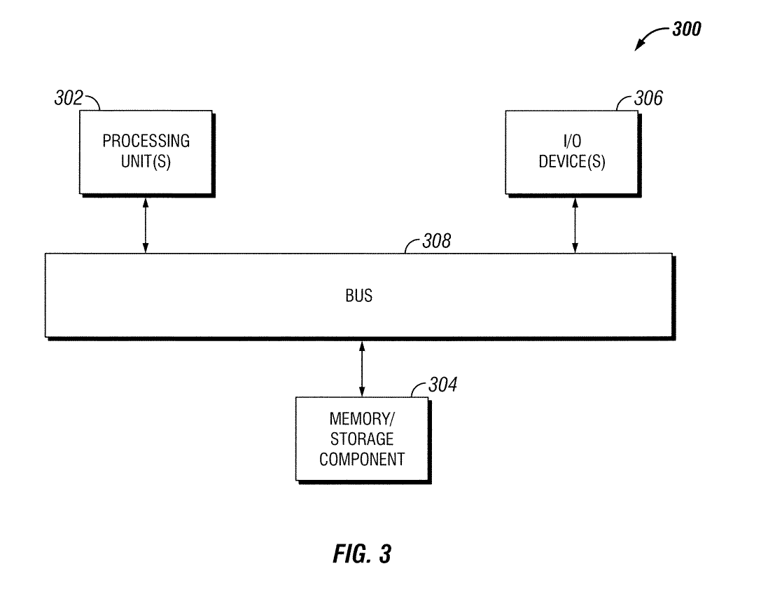

As discussed above, the user 150 and data sources 160, 162 use a user system and data source system, respectively, in certain exemplary embodiments. One or more of the user system and data source system is, or contains a form of, an Internet-based or an intranet-based computer system that is capable of communicating with the applicant software. A computer system includes any type of computing device and/or communication device, including but not limited to computer system 102. Examples of the user system and data source system includes, but are not limited to, a desktop computer with Internet or intranet access, a laptop computer with Internet or intranet access, a smart phone, a server, a server farm, and a personal digital assistant (PDA). The user system and/or data source system corresponds to a computer system as described below with regard to FIG. 3.

Further, as discussed above, the user system and/or data source system each have corresponding software (e.g., user software and data source software, respectively). The user software and data source software execute on a separate device (e.g., a server, mainframe, desktop personal computer (PC), laptop, personal desktop assistant (PDA), television, cable box, satellite box, kiosk, telephone, mobile phone, or other computing devices) from the computer system 102, the user 150 and/or the one or more data sources 160, 162, and is coupled by a network (e.g., Internet, Intranet, Extranet, Local Area Network (LAN), Wide Area Network (WAN), or other network communication methods), with wire and/or wireless segments according to some exemplary embodiments. The user software also is part of, or operates separately but in conjunction with, the computer system 102 and/or the one or more data sources 160, 162.

In one or more exemplary embodiments, one or more of the user software and data source software displays web page(s) (i.e., web content). More specifically, the user software and data source software is any software capable of rendering Hypertext Markup Language (HTML) in one or more exemplary embodiments. For example, the user software and data source software is a web browser(s) used by the corresponding system to access web pages (i.e., web content) over the Internet (or other Wide Area Network or Local Area Network). One or more of the user software and data source software also displays data in other formats, including but not limited to JavaScript®, JavaScript® Object Notation (JSON) and XML. (JavaScript is a registered trademark and service mark of Oracle America, Inc. of Redwood Shores, Calif.)

In one or more exemplary embodiments, one or more of the user software and data source software provides support for browser extension(s). More specifically, one or more of the user software and data source software provide an open framework (i.e., software design that allows for easy removal, addition, and/or replacement of software components) for adding features to the user software and/or data source software. In this case, a browser extension is an application that extends the functionality of the software using the open framework. The user software interacts with the computer system 102 and/or the one or more data sources 160, 162 using the browser extension(s). Further, the browser extension(s) interacts with a user interface of the user software (as well as a data source interface of data source software).

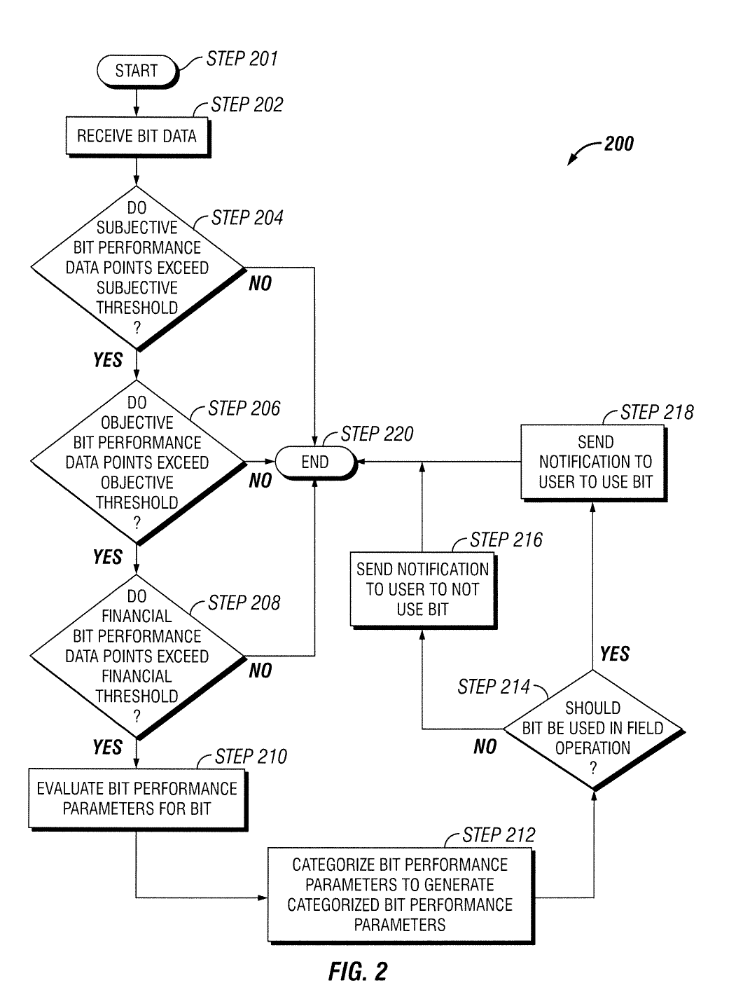

FIG. 2 is a flowchart of a method 200 for selecting a bit from a bit fleet for use in a field operation in accordance with one or more exemplary embodiments. The bit fleet includes both new bits and/or previously used bits according to certain exemplary embodiments. While the various steps in this flowchart are presented and described sequentially, one of ordinary skill in the art will appreciate that some or all of the steps are executed in different orders, combined or omitted, and some or all of the steps are executed in parallel depending upon the exemplary embodiment. Further, in one or more of the exemplary embodiments, one or more of the steps described below are omitted, repeated, and/or performed in a different order. In addition, a person of ordinary skill in the art will appreciate that additional steps not shown in FIG. 2, is included in performing this method in certain exemplary embodiments. Accordingly, the specific arrangement of steps should not be construed as limiting the scope. In addition, a particular computing device, as described, for example, in FIG. 3 below, is used to perform one or more of the steps for the method 200 described below in certain exemplary embodiments.

Now referring to FIGS. 1 and 2, the exemplary method 200 begins at the START Step 201 and proceeds to Step 202, where bit data for the bit fleet is received. The bit data is received from one or more of a number of data sources (e.g., data source 1 160, data source N 162). The bit data is received based on an inquiry (sent, for example, by the management engine 106 of the bit fleet management application 104). Alternatively, or in addition, the bit data is received at some periodic interval.

In Step 204, a determination is made as to whether subjective bit performance data points exceed a subjective threshold. Such a determination is made by the subjective module 108 of the bit fleet management application 104. There is a subjective threshold for each subjective bit performance data point according to some exemplary embodiments. When more than one subjective bit performance data point is being evaluated, each subjective bit performance data point is required to exceed its respective subjective threshold according to some exemplary embodiments. Alternatively, when more than one subjective bit performance data point is being evaluated, a minimum number of subjective bit performance data points is required to exceed its respective subjective threshold in other alternative exemplary embodiments. Those skilled in the art will appreciate that, when more than one subjective bit performance data point is being evaluated, one or more of a number of other methods are used to determine whether the subjective bit performance data points exceed the respective subjective threshold.

In order to determine whether the subjective bit data performance points exceed one or more of the subjective thresholds, the subjective bit data performance points are first evaluated. The subjective bit data performance points are evaluated by the subjective module 108 of the bit fleet management application 104. The subjective bit data performance points are evaluated using the bit data from one or more of the data sources (e.g., data source 1 160, data source N 162). If the subjective bit performance data points exceed the subjective threshold, the method 200 proceeds to Step 206. If the subjective bit performance data points do not exceed the subjective threshold, then the method 200 ends at the END Step 220.

In Step 206, a determination is made as to whether objective bit performance data points exceed an objective threshold. Such a determination is made by the objective module 110 of the bit fleet management application 104. There is an objective threshold for each objective bit performance data point according to some exemplary embodiments. When more than one objective bit performance data point is being evaluated, each objective bit performance data point is required to exceed its respective objective threshold according to certain exemplary embodiments. Alternatively, when more than one objective bit performance data point is being evaluated, a minimum number of objective bit performance data points are required to exceed its respective objective threshold in other exemplary embodiments. Those skilled in the art will appreciate that, when more than one objective bit performance data point is being evaluated, one or more of a number of other methods are used to determine whether the objective bit performance data points exceed the respective objective threshold.

In order to determine whether the objective bit data performance points exceed one or more of the objective thresholds, the objective bit data performance points are first evaluated. The objective bit data performance points are evaluated by the objective module 110 of the bit fleet management application 104. The objective bit data performance points are evaluated using the bit data from one or more of the data sources (e.g., data source 1 160, data source N 162) and/or the evaluation of the subjective bit performance data points. In certain exemplary embodiments, the objective bit performance data points are evaluated based on the subjective bit performance data points exceeding one or more of the subjective thresholds. If the objective bit performance data points exceed the objective threshold, the method 200 proceeds to Step 208. If the objective bit performance data points do not exceed the objective threshold, then the method 200 ends at the END Step 220.

In Step 208, a determination is made as to whether financial bit performance data points exceed a financial threshold. Such a determination is made by a financial module 112 of the bit fleet management application 104. There is a financial threshold for each financial bit performance data point according to some exemplary embodiments. When more than one financial bit performance data point is being evaluated, each financial bit performance data point is required to exceed its respective financial threshold according to certain exemplary embodiments. Alternatively, when more than one financial bit performance data point is being evaluated, a minimum number of financial bit performance data points are required to exceed its respective financial threshold according to certain exemplary embodiments. Those skilled in the art will appreciate that, when more than one financial bit performance data point is being evaluated, one or more of a number of other methods are used to determine whether the financial bit performance data points exceed the respective financial threshold.

In order to determine whether the financial bit data performance points exceed one or more of the financial thresholds, the financial bit data performance points are first evaluated. The financial bit data performance points are evaluated by the financial module 112 of the bit fleet management application 104. The financial bit data performance points are evaluated using the bit data from one or more of the data sources (e.g., data source 1 160, data source N 162), the evaluation of the subjective bit performance data points, and/or the evaluation of the objective bit performance data points. In certain exemplary embodiments, the financial bit performance data points are evaluated based on the subjective bit performance data points exceeding one or more of the subjective thresholds and/or based on the objective bit performance data points exceeding one or more of the objective thresholds. If the financial bit performance data points exceed the financial threshold, the method 200 proceeds to Step 210. If the financial bit performance data points do not exceed the financial threshold, then the method 200 ends at the END Step 220.

In Step 210, the bit performance parameters for the bit are evaluated. The bit performance parameters are evaluated by the management engine 106. The bit performance parameters are evaluated using the hardware processor 120. The bit performance parameters are evaluated based on the determining that the subjective bit performance parameters exceed one or more of the subjective thresholds, that the objective bit performance parameters exceed one or more of the objective thresholds, and/or that the financial bit performance parameters exceed one or more of the financial thresholds. The bit performance parameters also are, or additionally, evaluated using the bit data 140. Other data (e.g., geologic data, performance data, financial data) associated with the field in which the field operation is being performed is used in certain exemplary embodiments. One or more of the bit performance parameters are evaluated using an algorithm. The evaluation for one or more of the bit performance parameters are a numeric score, with units (e.g., feet) or without units (e.g., a percentage).

In Step 212, the bit performance data parameters are categorized to generate categorized bit performance data parameters. The bit performance data parameters are categorized by the management engine 106. Categorizing the bit performance data parameters includes comparing a score (e.g., a percentage) of the bit performance data parameter against two or more ranges of scores for the bit performance data parameter. For example, if the bit performance data parameter of Wellbore Quality is evaluated as having a score of 50% in Step 210, then the management engine 106 categorizes the Wellbore Quality as “Bad” because the “Bad” rating category captures any bit with a Wellbore Quality of between 26% and 100%. Alternatively, if the bit performance data parameter of Wellbore Quality is evaluated as having a score of 5% in Step 210, then the management engine 106 categorizes the Wellbore Quality as “Good” because the “Good” rating category captures any bit with a Wellbore Quality of between 0% and 10%.

In Step 214, a determination is made as to whether the bit should be used in the field operation. The determination is made by the management engine 106 of the bit fleet management application 104. The determination is based on one or more of the categorized bit performance parameters. The determination is made using one or more algorithms. Such algorithms is based on user input, a default setting, one or more rules, and/or any other suitable factor. In one or more exemplary embodiments, it may not only be determined that the bit should not be used for the field operation, but that the bit is damaged beyond repair (DBR). If the bit is determined to not be used in the field operation, then the method 200 proceeds to Step 216. If the bit is able to be used in the field operation, then the method 200 proceeds to Step 218.

In Step 216, a notification is sent to the user 150 not to use the bit. In certain exemplary embodiments, the notification also notify the user 150 that the bit is classified as DBR. The notification is sent by the management engine 106 of the bit fleet management application 104. The notification is presented in any suitable format, including but not limited to text, a picture, a graphic, and or audio. The notification includes one or more of a number of information, including but not limited to the bit performance parameters and the evaluation of the bit performance parameters. After Step 216 is completed, the method 200 ends at the END Step 220.

In Step 218, a notification is sent to the user 150 that the bit is usable. The notification is sent by the management engine 106 of the bit fleet management application 104. The notification is presented in any suitable format, including but not limited to text, a picture, a graphic, and or audio. The notification includes one or more of a number of information, including but not limited to the bit performance parameters and the evaluation of the bit performance parameters. After Step 218 is completed, the method 200 ends at the END Step 220.

FIG. 3 illustrates one embodiment of a computing device 300 that implements one or more of the various techniques described herein, and which is representative, in whole or in part, of the elements described herein pursuant to certain exemplary embodiments. Computing device 300 is one example of a computing device and is not intended to suggest any limitation as to scope of use or functionality of the computing device and/or its possible architectures. Neither should computing device 300 be interpreted as having any dependency or requirement relating to any one or combination of components illustrated in the example computing device 300.

Computing device 300 includes one or more processors or processing units 302, one or more memory/storage components 304, one or more input/output (I/O) devices 306, and a bus 308 that allows the various components and devices to communicate with one another. Bus 308 represents one or more of any of several types of bus structures, including a memory bus or memory controller, a peripheral bus, an accelerated graphics port, and a processor or local bus using any of a variety of bus architectures. Bus 308 includes wired and/or wireless buses.

Memory/storage component 304 represents one or more computer storage media. Memory/storage component 304 includes volatile media (such as random access memory (RAM)) and/or nonvolatile media (such as read only memory (ROM), flash memory, optical disks, magnetic disks, and so forth). Memory/storage component 304 includes fixed media (e.g., RAM, ROM, a fixed hard drive, etc.) as well as removable media (e.g., a Flash memory drive, a removable hard drive, an optical disk, and so forth).

One or more I/O devices 306 allow a customer, utility, or other user to enter commands and information to computing device 300, and also allow information to be presented to the customer, utility, or other user and/or other components or devices. Examples of input devices include, but are not limited to, a keyboard, a cursor control device (e.g., a mouse), a microphone, and a scanner. Examples of output devices include, but are not limited to, a display device (e.g., a monitor or projector), speakers, a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 300 is connected to a network (not shown) (e.g., a local area network (LAN), a wide area network (WAN) such as the Internet, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 300 includes at least the minimal processing, input, and/or output means necessary to practice one or more embodiments.

Further, those skilled in the art will appreciate that one or more elements of the aforementioned computer device 300 is located at a remote location and connected to the other elements over a network in certain exemplary embodiments. Further, one or more embodiments is implemented on a distributed system having one or more nodes, where each portion of the implementation (e.g., management engine 106, financial module 112) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

The following description (in conjunction with FIGS. 1 through 3) describes an example in accordance with one or more exemplary embodiments. The example is for selecting a bit of a bit fleet for use in a field operation. Terminology used in FIGS. 1 through 3 is used in the provided example without further reference to FIGS. 1 through 3.

### EXAMPLE

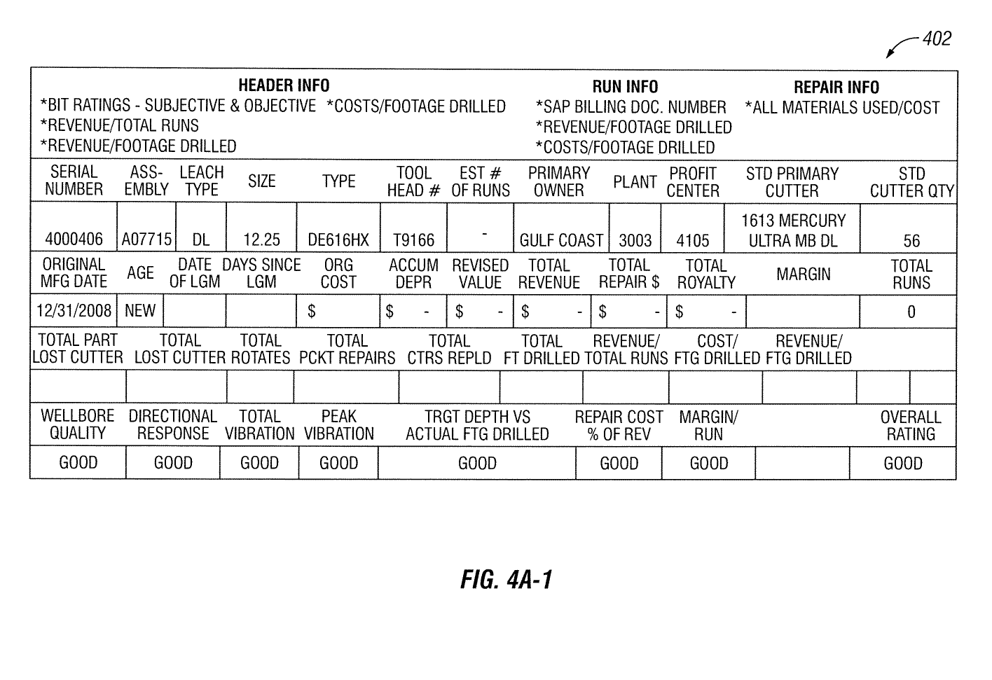

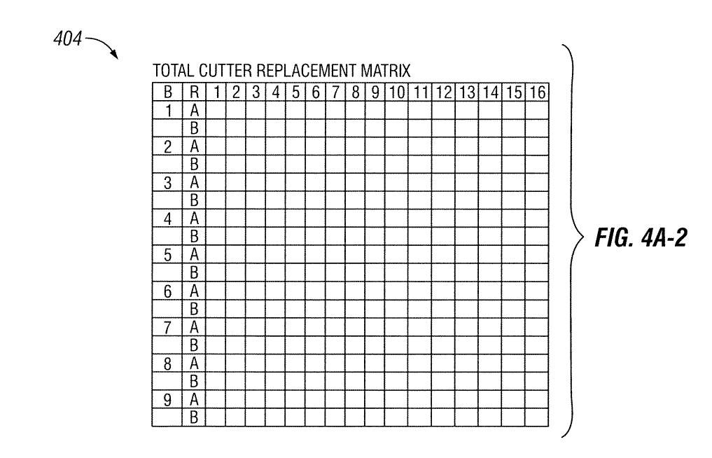

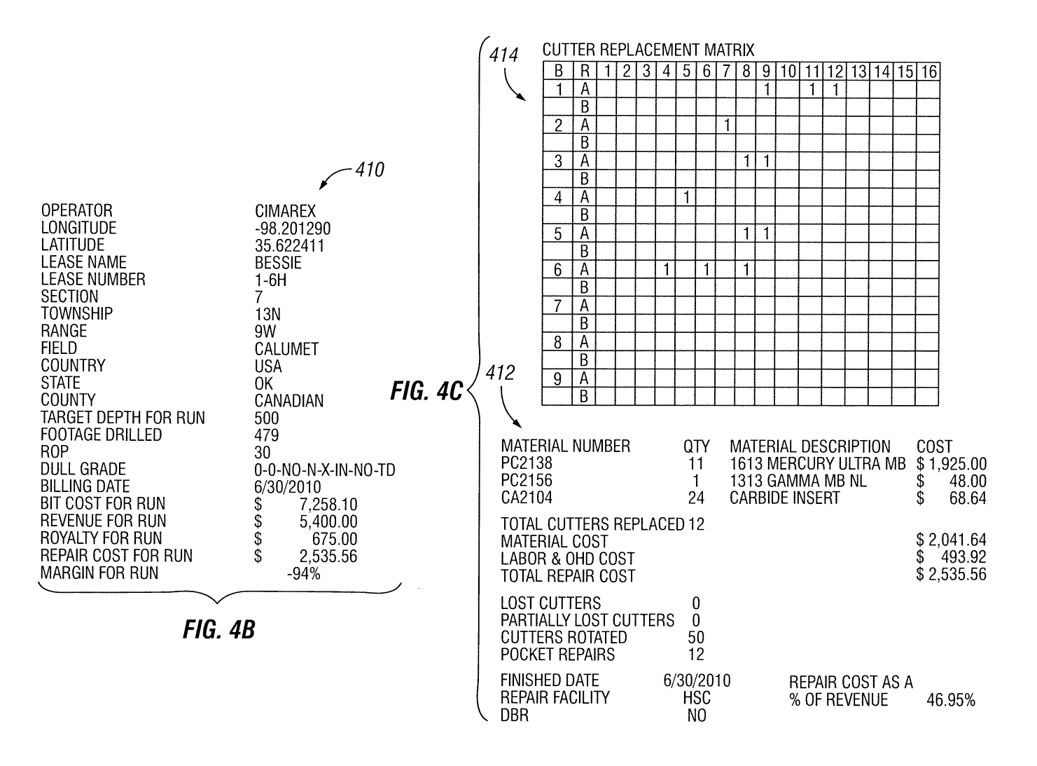

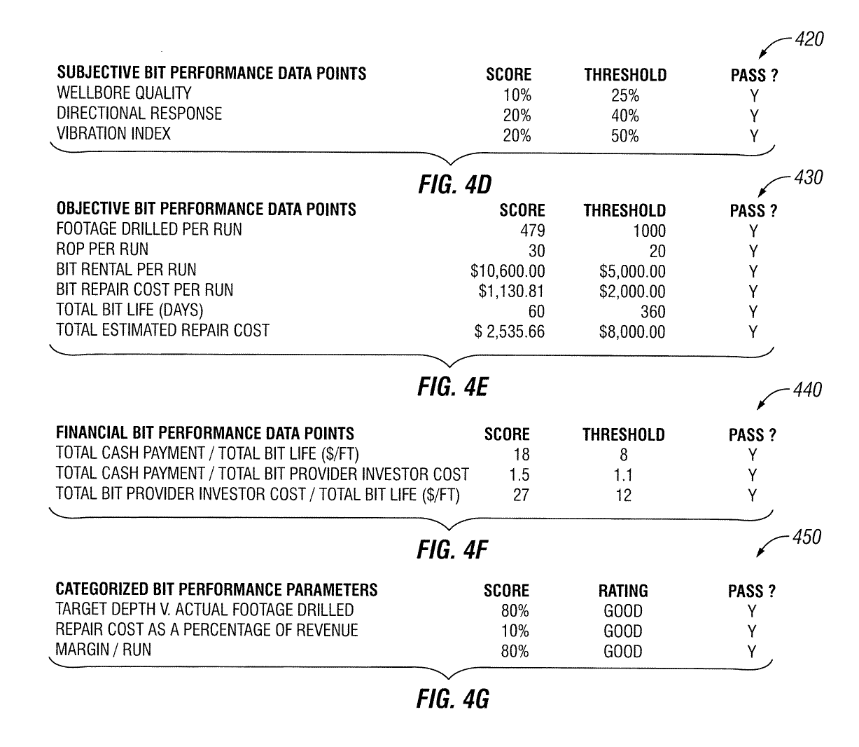

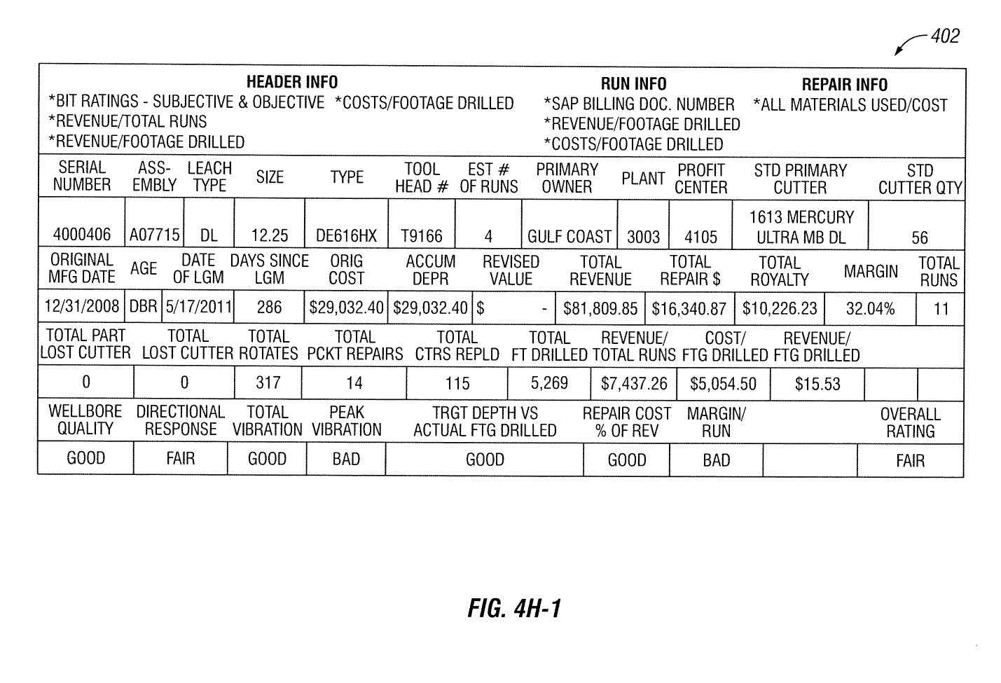

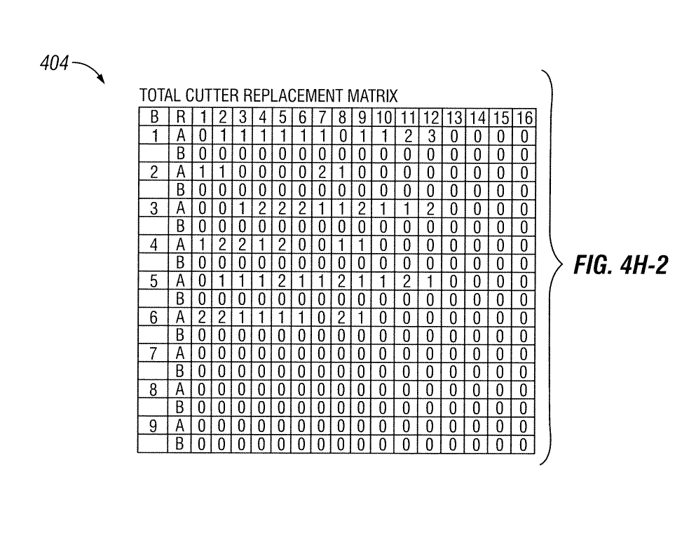

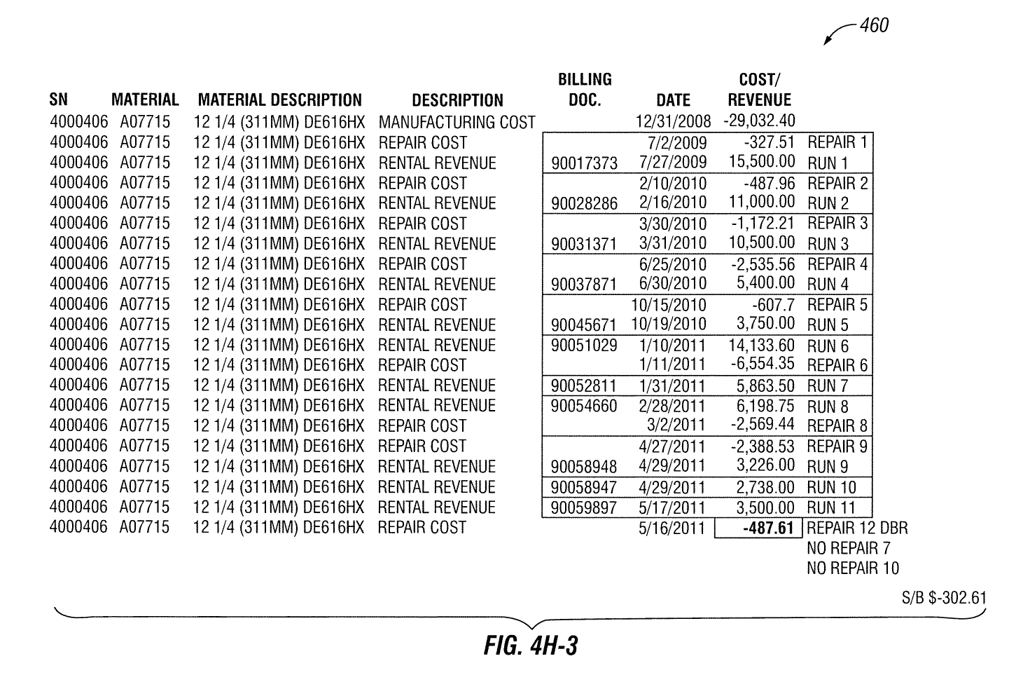

Consider the following example, shown in FIGS. 4A through 4H, which describes selecting a bit of a bit fleet for use in a field operation in accordance with one or more exemplary embodiments described above. FIG. 4A-1 shows a summary table 402 of the bit data when the bit is purchased. The bit is part of a bit fleet. Each field in the summary table 402 shown in FIG. 4A-1 corresponds to an element of the bit data. Many of the fields in the summary table 402 shown in FIG. 4A-1 are blank because the bit has not yet been used in a field operation. The bit data shown in FIG. 4A-1 is any data associated with the bit that is used to determine the usefulness of the bit in a particular field operation. In addition, the bottom row of the summary table 402 shows the rating category for each of the categorized bit performance parameters. In this example, because the bit has not yet been used in the field, the ratings are “Good” for each categorized bit performance parameter.

FIG. 4A-2 includes a cutter replacement table 404 showing the cutter replacements for the bit. The cutter replacement table 404 is laid out in one of a number of configurations. Here, a matrix is presented where the columns show the position (1-16) of the cutter on a bit, and the rows show the row number and blade number of the bit. Initially, none of the fields in the cutter replacement table 404 have a value because none of the cutters on the bit has been replaced.

Referring now to FIG. 4B, a table 410 is shown after the bit has completed a fourth run. Information about the particular bit run, as well as the corresponding results of the bit run, is shown in the table 410. The operational data is shown in the table 410, which shows operational and financial data associated with the run using the bit. The margin for the bit run is at −94%.

To determine whether to repair the bit and use the bit in a subsequent run, the bit is evaluated as described herein using estimates for repairing the bit. FIG. 4C shows the estimated repair data for the bit after the fourth run. The estimated repair data shown in the left portion 412 of FIG. 4C includes parts (including quantity and cost) that were replaced, number of cutters lost and rotated, who performed the repairs, and whether the bit is classified as DBR. The right portion 414 of FIG. 4C shows the cutter replacement matrix required to repair the bit for the subsequent run.

FIG. 4D gives a tabular summary 420 of the subjective bit performance data points relative to the corresponding subjective thresholds. Specifically, the subjective bit performance data points are wellbore quality, directional response, and vibration index. The scores for each subjective bit performance data point, as determined by the subjective module of the bit fleet management application, are 10% for the wellbore quality, 20% for the directional response, and 20% for the vibration index. Because the subjective threshold for the wellbore quality is 25%, the wellbore quality passes. Because the subjective threshold for the directional response is 40%, the directional response passes. As previously mentioned, these thresholds are different in other exemplary embodiments. Because the subjective threshold for the vibration index is 50%, the vibration index passes. In summary, because the subjective bit performance data points exceed the subjective thresholds, the method continues to evaluating the objective bit performance data points.

FIG. 4E gives a tabular summary 430 of the objective bit performance data points relative to the corresponding objective thresholds. Specifically, the objective bit performance data points are footage drilled per run, rate of penetration (ROP) per run, bit rental per run, bit repair cost per run, total bit life, and total estimated repair cost. The scores for each objective bit performance data point, as determined by the objective module of the bit fleet management application, are 479 for the footage drilled per run, 30 for the ROP per run, $10,600 for the bit rental per run, $1,130.81 for the bit repair cost per run, 60 days for the total bit life, and $2,535.66 for the total estimated repair cost. Because the objective threshold for the footage drilled per run is 1,000, the footage drilled per run passes. Because the objective threshold for the ROP per run is 20, the ROP per run passes. Because the objective threshold for the bit rental per run is $5,000, the bit rental per run passes. Because the objective threshold for the bit repair cost per run is $2,000, the bit repair cost per run passes. Because the objective threshold for the total bit life is 360 days, the total bit life passes. Because the objective threshold for the total estimated repair cost is $8,000, the total estimated repair cost passes. As previously mentioned, these thresholds are different in other exemplary embodiments. In summary, because the objective bit performance data points exceed the objective thresholds, the method continues to evaluating the financial bit performance data points. In certain exemplary embodiments, the method continues to evaluate the financial bit performance data points even if not all the objective bit performance data points exceed all the objective thresholds.

FIG. 4F gives a tabular summary 440 of the financial bit performance data points relative to the corresponding financial thresholds. Specifically, the financial bit performance data points are total cash payment divided by total bit life (in dollars per foot), total cash payment divided by total bit provider investor cost, and total bit provider investor cost divided by total bit life (in dollars per foot). The scores for each financial bit performance data point, as determined by the financial module of the bit fleet management application, are 18 for the total cash payment divided by total bit life, 1.5 for the total cash payment divided by total bit provider investor cost, and 27 for the total bit provider investor cost divided by total bit life. Because the financial threshold for the total cash payment divided by total bit life is 8, the total cash payment divided by total bit life passes. Because the financial threshold for the total cash payment divided by total bit provider investor cost is 1.1, the total cash payment divided by total bit provider investor cost passes. Because the financial threshold for the total bit provider investor cost divided by total bit life is 12, the total bit provider investor cost divided by total bit life passes. As previously mentioned, these thresholds are different in other exemplary embodiments. In summary, because the financial bit performance data points exceed the financial thresholds, the method continues to evaluating the bit performance parameters for the bit. In certain exemplary embodiments, the method continues to evaluate the bit performance parameters for the bit even if not all the financial bit performance data points exceed all the financial thresholds.

FIG. 4G gives a tabular summary 450 of the categorized bit performance parameters for the bit. Specifically, the categorized bit performance parameters are target depth versus actual footage drilled, repair cost as a percentage of revenue, and margin per run. The scores for each categorized bit performance parameter, as determined by the management engine of the bit fleet management application, are 80% for the target depth versus actual footage drilled, 10% for the repair cost as a percentage of revenue, and 80% for the margin per run. Because the rating category of “Good” for the target depth versus actual footage drilled is between 75% and 100%, the target depth versus actual footage drilled is categorized as “Good”. Because the rating category of “Good” for the repair cost as a percentage of revenue is between 0% and 25%, the repair cost as a percentage of revenue is categorized as “Good”. Because the rating category of “Good” for the margin per run is between 75% and 100%, the margin per run is categorized as “Good”. In summary, because the bit performance parameters are all categorized as “Good,” the management engine determines that the bit should be repaired and used for the field operation.

Based on the categorized bit performance parameters for the bit, a notification is sent to the user to repair the bit and use the repaired bit for run number 5. If the actual repair costs are more than the estimated repair costs, then the steps performed in this example is rerun, in certain exemplary embodiments, using the actual repair costs. A table showing exemplary scores corresponding to exemplary rating categories for a number of exemplary categorized bit performance parameters is shown below. Those skilled in the art will appreciate that one or more changes (e.g., different names for the rating categories, more rating categories, fewer rating categories, different scores and/or ranges of scores, different categorized bit performance parameters, more categorized bit performance parameters, fewer categorized bit performance parameters) may be made to the table below for a particular application using exemplary embodiments described herein.

| Categorized Bit | | | |
|---|---|---|---|
| Performance | | | |
| Parameter | Good | Fair | Bad |
| Target depth vs. | 75%-100% | 26%-74% | 0%-25% |
| actual footage drilled | | | |
| Repair cost as a | 0%-25% | 26%-40% | 41%-100% |
| percentage of | | | |
| revenue | | | |
| Margin per run | 75%-100% | 26%-74% | 0%-25% |
| Wellbore quality | 0%-10% | 11%-25% | 26%-100% |
| Directional response | 0%-20% | 21%-40% | 41%-100% |
| Vibration index | 0%-20% | 21%-50% | 51%-100% |

FIG. 4H-1 shows the summary table 402 of the bit data after the bit has completed 11 runs. Here, the bottom row of the summary table 402 has a rating category of “Good” for the categorized bit performance parameters of wellbore quality, total vibration, target depth versus actual footage drilled, and repair cost as a percentage of revenues. In addition, the categorized bit performance parameter of directional response has a rating category of “Fair”, and the categorized bit performance parameters of peak vibration and margin per run have a rating category of “Bad”. As a result, the overall rating category is “Fair”, and the bit is classified as damaged beyond repair (DBR). In FIG. 4H-2, the total cutter replacement table 404 shows the number and location of all cutters that have been replaced during the life of the bit. Finally, in FIG. 4H-3, the table 460 shows the costs and revenues per run over the life of the bit. Based on the evaluation of the bit, after 11 runs, a determination is made that the bit is DBR.

One or more exemplary embodiments provide for ensuring that the bit selected for a field operation performs the best out of the bit fleet, while also providing adequate financial returns for the bit provider. Exemplary embodiments are used to analyze a single bit, a single bit type, a small bit fleet in a specific region, a fleet of bits across regions, or any other combination of bits and/or regions. Certain embodiments are used to analyze the cost/benefit return of changes in cutter class, cutter cost, bit type, bit repair timing or criteria, and/or any other variable associated with the bit. The risks and rewards are analyzed in terms of both the operator and the bit provider.

Exemplary embodiments described herein are used to identify and isolate “overbuilt” or “overspecified” drill bits that are not economically viable. Alternative bit types and/or cutter classes are determined using the exemplary embodiments described herein. Exemplary embodiments are scalable from a single rig drilling a single well section to an analysis of, for instance, a specific operator's global drill bit relationship with a drill bit provider. Exemplary embodiments are used to analyze the cost/benefit performance of competitive drill bits in the marketplace to provide a bit provider insight into the bit provider's competitive positioning. Using exemplary embodiments, the performance of cutter classes, from a specific vendor and/or across vendors, is analyzed to better position a bit provider to choose an appropriate cutter class at a cost for a specific field (or portion of a field, as at a particular depth and/or formation type of a field), customer, and/or application.

Exemplary embodiments described herein are used to evaluate PDC bits. Alternatively, or in addition, other types of bits (e.g., roller cone bits, reamers, hole openers) are evaluated using exemplary embodiments. In addition, or in the alternative, exemplary embodiments are used to analyze and evaluate tools that effect bit performance and bit life. Examples of such tools include, but are not limited to, torque reducers, impact tools, down hole motors, and turbines.

Although selecting a bit from a bit fleet for use in a field operation is described with reference to some exemplary embodiments, it should be appreciated by those skilled in the art that various modifications are well within the scope of selecting a bit from a bit fleet for use in a field operation. From the foregoing, it will be appreciated that an embodiment of selecting a bit from a bit fleet for use in a field operation overcomes the limitations of the prior art. Those skilled in the art will appreciate that selecting a bit from a bit fleet for use in a field operation is not limited to any specifically discussed application and that the exemplary embodiments described herein are illustrative and not restrictive. From the description of the exemplary embodiments, equivalents of the elements shown therein will suggest themselves to those skilled in the art, and ways of constructing other embodiments of selecting a bit of a bit fleet for use in a field operation will suggest themselves to practitioners of the art. Therefore, the scope of selecting a bit from a bit fleet for use in a field operation is not limited herein.

1. A system for selecting a polycrystalline diamond compact (PDC) bit of a bit fleet for use in a field operation, the system comprising:
a hardware processor;
a subjective module executing on the hardware processor and determining, using one or more bit data received from one or more data sources, that one or more subjective bit performance data points exceed a corresponding subjective threshold for the field operation;
an objective module executing on the hardware processor and determining, using one or more bit data, that one or more objective bit performance data points exceed a corresponding objective threshold for the field operation;
a financial module executing on the hardware processor and determining, using one or more bit data, that one or more financial bit performance data points exceed a corresponding financial threshold for the field operation; and
a management engine executing on the hardware processor and:
receiving the one or more bit data from the one or more data sources;
evaluating, using the one or more bit data and based on determining performed by the subjective module, the objective module, and the financial module, one or more bit performance parameters for the PDC bit;
categorizing each of the one or more bit performance parameters to generate one or more categorized bit performance parameters; and
determining, based on the categorized bit performance parameters, whether the PDC bit is usable in the field operation,
wherein the one or more bit data comprises information about a plurality of replaceable cutters of the PDC bit.

2. The system of claim 1, wherein the subjective module also evaluates, using the one or more bit data received from the one or more data sources, the one or more subjective bit performance data points for the PDC bit of the bit fleet.

3. The system of claim 1, wherein the objective module also evaluates, using the one or more bit data, the one or more objective bit performance data points for the PDC bit of the bit fleet.

4. The system of claim 3, wherein the one or more objective bit performance data points is evaluated based on the one or more subjective bit performance data points exceeding the subjective threshold.

5. The system of claim 1, wherein the financial module also evaluates, using the one or more bit data, the one or more financial bit performance data points for the PDC bit.

6. The system of claim 5, wherein the one or more financial bit performance data points is evaluated based on the one or more objective bit performance data points exceeding the objective threshold.

7. The system of claim 6, wherein the one or more bit performance parameters is evaluated based on the one or more financial bit performance data points exceeding the financial threshold.

8. The system of claim 1, wherein the management engine also sends a notification to a user, wherein the notification comprises the categorized bit performance parameters to indicate whether the PDC bit should be used in the field operation.

9. The system of claim 1, wherein the management engine determines that the PDC bit is damaged beyond repair.

10. (canceled)

11. The system of claim 1, wherein the one or more subjective bit performance data points comprises at least one selected from a group consisting of wellbore quality, directional response/drilling target acquisition, total vibration, and peak vibration.

12. The system of claim 1, wherein the one or more objective bit performance data points comprises at least one selected from a group consisting of footage drilled per run, rate of penetration per run, bit rental per run, bit repair cost per run, bit cost, total bit life, cutter class, and cutter cost.

13. The system of claim 1, wherein the one or more financial bit performance data points comprises at least one selected from a group consisting of total cash payment divided by total bit life, total cash payment divided by total bit provider invested cost, and total bit provider invested cost divided by total bit life.

14. The system of claim 1, wherein the one or more bit performance parameters comprises at least one selected from a group consisting of target depth versus actual footage drilled, repair cost as a percentage of revenue, margin per run, wellbore quality, directional response, and vibration index.

15. The system of claim 1, wherein the bit data comprises a bit serial number, a bit assembly number, a bit type, a bit usage region, and a usage zone longitude and latitude.

16. A computer-implemented method for selecting a polycrystalline diamond compact (PDC) bit of a bit fleet for use in a field operation, the method comprising:
receiving, from a one or more data sources, a one or more bit data for the bit fleet;
determining, using a hardware processor, that a one or more subjective bit performance data points exceeds a subjective threshold for the field operation;
determining, using a hardware processor, that a one or more objective bit performance data points exceeds an objective threshold for the field operation;
determining, using a hardware processor, that a one or more financial bit performance data points exceeds a financial threshold for the field operation;
evaluating, using the one or more bit data and a hardware processor, a one or more bit performance parameters for the PDC bit;
categorizing, using a hardware processor, each of the one or more bit performance parameters to generate categorized bit performance parameters; and
determining, based on the categorized bit performance parameters, whether the PDC bit should be used in the field operation,
wherein the one or more bit data comprises information about a plurality of replaceable cutters of the PDC bit.

17. The method of claim 16, further comprising:
sending a notification to a user, wherein the notification comprises the categorized bit performance parameters to indicate that the PDC bit should be used in the field operation.

18. The method of claim 16, further comprising:
determining that the PDC bit is damaged beyond repair and should not be used in the field operation.

19. The method of claim 16, further comprising:
evaluating, using the one or more bit data received from the one or more data sources, the one or more subjective bit performance data points for the PDC bit of the bit fleet.

20. A non-transitory computer readable medium comprising computer readable program code embodied therein for selecting a polycrystalline diamond compact (PDC) bit of a bit fleet for use in a field operation, the method comprising:
receiving, from a one or more data sources, a one or more bit data for the bit fleet;
determining that a one or more subjective bit performance data points exceeds a subjective threshold for the field operation;
determining that a one or more objective bit performance data points exceeds an objective threshold for the field operation;
determining that a one or more financial bit performance data points exceeds a financial threshold for the field operation;
evaluating, using the one or more bit data, a one or more bit performance parameters for the PDC bit;
categorizing each of the one or more bit performance parameters to generate categorized bit performance parameters; and
determining, based on the categorized bit performance parameters, that the PDC bit should be used in the field operation,.
wherein the one or more bit data comprises information about a plurality of replaceable cutters of the PDC bit.

21. The system of claim 1, wherein at least one of the plurality of cutters has been replaced.
